(19) United States
(12) Patent Application Publication
(10) Pub. No.: US 2006/0226730 A1
(43) Pub. Date: Oct. 12, 2006

(54) Brush assembly for dynamoelectric machines having increased wear life

(76) Inventor: David A. Fulton, Anderson, IN (US)

Correspondence Address: CANTOR COLBURN, LLP, 55 GRIFFIN ROAD SOUTH, BLOOMFIELD, CT, 06002, US

(21) Appl. No.: 11/103,207

(22) Filed: Apr. 11, 2005

(51) Int. Cl. H01R 39/38; H01R 39/44

(52) U.S. Cl. 310/239; 310/241; 310/242

(57) ABSTRACT

A brush assembly for dynamoelectric machines includes a curved brush holder, and a curved brush disposed within the curved brush holder, wherein the curved brush further includes a substantially constant radius of curvature along an entire length thereof.

### BACKGROUND

The present invention relates generally to rotating electric machinery and, more particularly, to a brush assembly for dynamoelectric machines having an increased wear life.

Brushes used in certain types of dynamoelectric machinery are typically made from materials such as carbon, graphite, metal graphite, and a mixture of carbon and graphite. They have a high conductivity for reducing electrical losses, as well as a low coefficient of friction to reduce excessive wear, and are intentionally made from a softer material that the rotating surface (e.g., commutator, slip rings) in contact therewith, so that the rotating surface will suffer relatively little wear. The choice of brush hardness is a compromise; if the brushes are too soft, they will need to be replaced often. On the other hand, if they are too hard, the rotating surface will wear excessively over the life of the machine.

Thus, brush type electrical connections wear with operation of the electric machine, due to electrical and mechanical erosion of the brushes. This is true for both commutator (e.g., brush DC motors) and slip ring (e.g., brush wound-field synchronous alternators) applications. Generally speaking, for a given brush pressure, machine speed and brush current density, the time that it takes to erode the brush is proportional to the brush length. It stands to reason, therefore, that by increasing the length of the brushes, the durability of the electric machine can also be increased (assuming that the brush life is the dominant failure mode of the machine).

Another consideration, however, is that fact that for certain applications (such as motor vehicle alternators, starter motors, and the like) the size of the electric machine becomes a significant design consideration. Currently, straight brushes are used in brush-type electric machines, generally extending along radial lines from the axis of rotation, or may extend at a small angle from a radial line. As such, an increase in the length of the brush (in order to provide a brush with longer wear life) can result in an undesirable increase the frame size of the machine. This is particularly the case when the brush/spring/holder assembly lies in the dimensional stack-up that determines the minimum frame size.

Accordingly, it would be desirable to be able to extend the life of a brush for a dynamoelectric machine without a corresponding significant increase in the size of the machine itself.

### SUMMARY

The foregoing discussed drawbacks and deficiencies of the prior art are overcome or alleviated by a brush assembly for dynamoelectric machines. In an exemplary embodiment, the brush assembly includes a curved brush holder, and a curved brush disposed within the curved brush holder, wherein the curved brush further includes a substantially constant radius of curvature along an entire length thereof.

In another embodiment, a brush assembly for a DC motor includes a curved brush holder, and a curved brush disposed within the curved brush holder, wherein the curved brush further includes a substantially constant radius of curvature along an entire length thereof. One end of the curved brush is configured for traveling contact with a commutator of the DC motor.

In still another embodiment, a brush assembly for an alternator includes a curved brush holder, and a curved brush disposed within the curved brush holder, wherein the curved brush further includes a substantially constant radius of curvature along an entire length thereof. One end of the curved brush is configured for traveling contact with a slip ring of the alternator.

### BRIEF DESCRIPTION OF THE DRAWINGS

Referring to the exemplary drawings wherein like elements are numbered alike in the several Figures:

FIG. 1 illustrates an example of an existing brush assembly for a DC starter motor;

FIG. 2 illustrates an example of an existing brush assembly for an alternator;

FIG. 3 illustrates the brush assembly of FIG. 2 mounted to the slip rings of the alternator;

FIG. 4 illustrates a curved brush assembly for a DC starter motor, in accordance with an embodiment of the invention;

FIG. 5 illustrates an alternative embodiment of the curved brush assembly of FIG. 4;

FIGS. 6 and 7 illustrate a more detailed view of the curved brush assembly of FIG. 4; and

FIGS. 8 and 9 illustrate a side-by-side comparison of a conventional brush assembly for an alternator (FIG. 8) with a curved brush assembly for an alternator (FIG. 9), in accordance with a further embodiment of the invention.

### DETAILED DESCRIPTION

Disclosed herein is a brush assembly for dynamoelectric machines having an increased wear life. Briefly stated, the use of curved brushes makes it is possible to substantially increase brush length without a corresponding increase in the frame size of the machine. In other words, for a given amount of brush length increase, a curved brush configuration will increase the overall frame size less than would be the case for a length increase for a straight brush configuration. In this manner, curved brushes can provide a brush life increase with substantially the same package size as a straight brush configuration, or, alternatively, a package size decrease with the same brush life as a straight brush configuration.

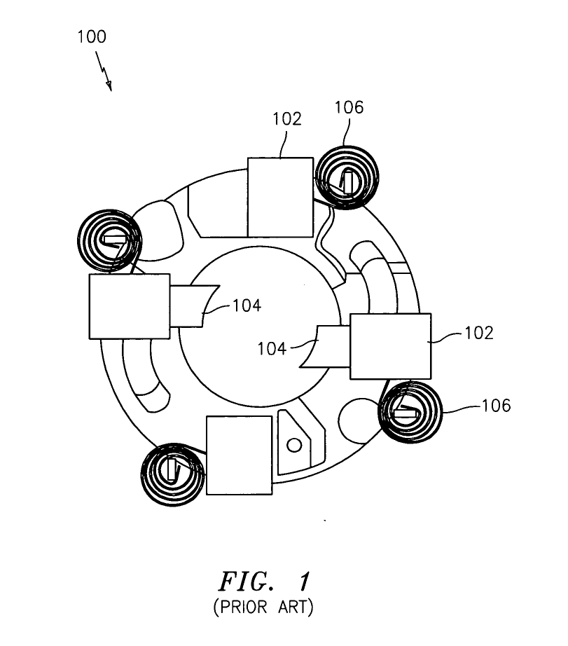

FIG. 1 illustrates an example of an existing brush assembly 100 for a DC starter motor. As is shown, the brush assembly 100 includes a plurality of brush holders 102, two of which are shown having a brush 104 inserted therein. In order to hold the brushes 104 against the current collector (e.g., commutator in the case of a DC motor, not shown in FIG. 1), a spring 106 is used. The spring 106 must apply appropriate force to the brush over its full life, and thus the spring must have adequate range of motion to follow the brush 104 as it wears, as well as the ability to apply the correct range of force in following the brush. A braided wire cable, referred to as a brush shunt (not shown in FIG. 1), is also commonly attached to the brush in order to make electrical connection to the brush over its entire range of motion. The conventional brush geometry of FIG. 1 is generally created by extruding a given cross-section (typically rectangular) in a straight line, along the entire length of the brush.

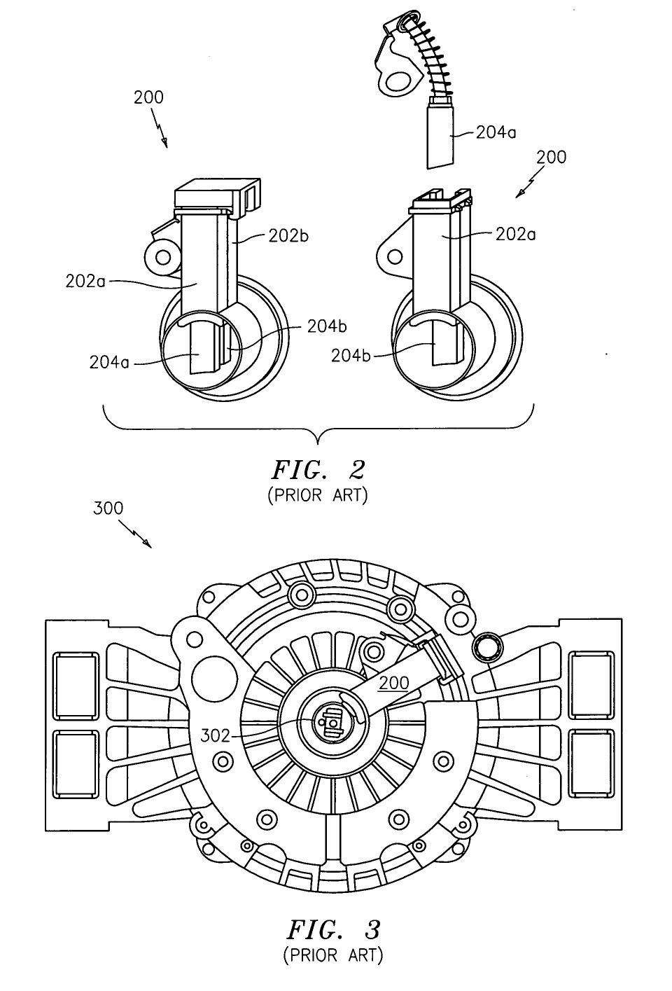

FIG. 2 illustrates another example of an existing brush assembly 200, particularly configured for an alternator. The assembly 200 includes a pair of adjacent brush holders 202a, 202b, that each contain a corresponding brush 204a, 204b, therein for making electrical contact with a pair of slip rings (not shown). The assembly 200 on the right side of FIG. 2 is shown with one of the brushes 204a removed from its brush holder for purposes of illustration. FIG. 3 illustrates the brush assembly 200 of FIG. 2 mounted to the slip rings 302 of the alternator 300.

Regardless of the type of machine used, extending the life of a conventionally shaped brush by increasing the brush length can make it more difficult to package a brush spring and brush shunt that can follow the full range of brush motion. The brush spring rate is preferably kept low, in order to minimize the drop in brush force as the brush wears. In addition, the free length of the spring must be long enough to maintain contact with the brush. These factors together tend to increase the compressed size of the spring.

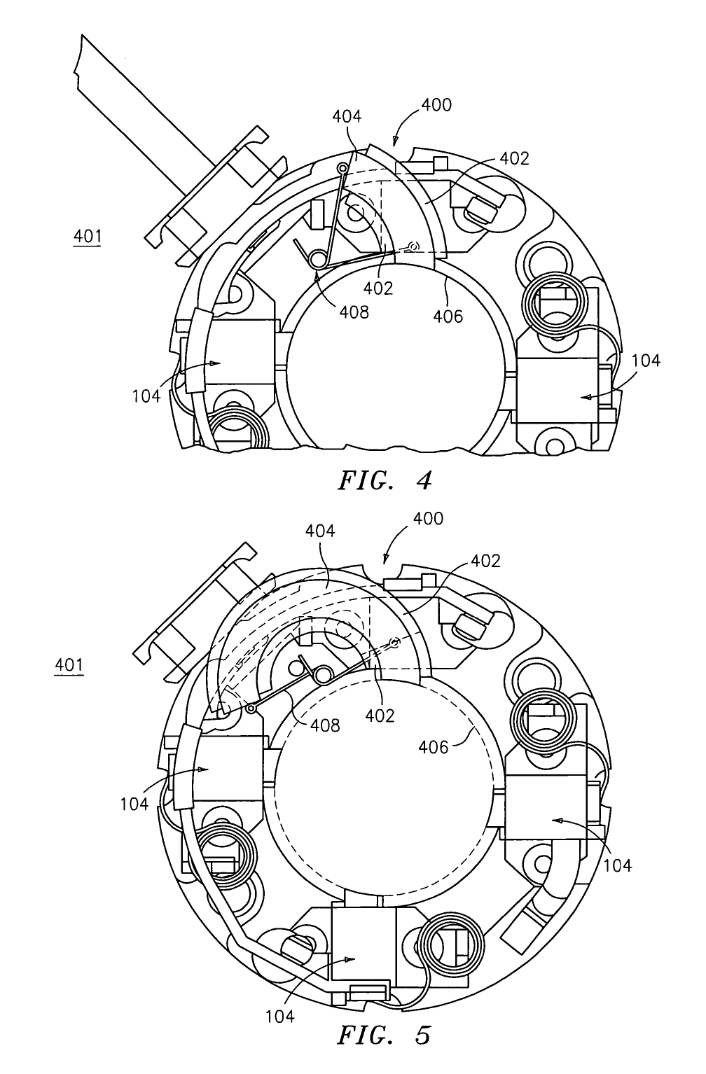

Therefore, in accordance with an embodiment of the invention, FIG. 4 illustrates a curved brush assembly 400 suitable for use in conjunction with (for example) a DC starter motor 401. For purposes of illustration and contrast, however, the motor 402 shown in FIG. 4 also illustrates the more conventional straight axis brushes 104. In particular, the curved brush assembly includes a curved brush holder 402 that retains a curved brush 404 therein, with the curved brush shape being formed by extruding the brush material cross-section along a curve of a substantially constant radius. As will thus be seen, by utilizing curved brushes in lieu of a straight configuration, a frame size or brush life benefit may be achieved.

The brush 404 initially points radially outward from the commutator 406 (or slip ring in the case of an AC machine), but then curves back toward the machine's axis of rotation. This is perhaps best illustrated in the alternative embodiment of the brush assembly 400 shown in FIG. 5, in which a the same radius of curvature is used, but the length of the brush assembly 400 is extended. Whereas the brush 404 in the embodiment of FIG. 4 is about 20% longer than the conventional straight brushes, the brush 404 in the embodiment of FIG. 5 is about twice the length of a conventional straight brush. Accordingly, the frame size needed to house a given length of brush is therefore reduced in the present configuration. It should be noted, however, that the particular radius of curvature and length of the brush may be selected as desired.

The exemplary DC motor 401 of FIG. 4 and 5 is configured to accommodate a total of four brush assemblies. In one contemplated embodiment, each assembly may comprise the disclosed curved configuration 400 herein. Alternatively, some assemblies may be curved, while others may comprise a straight configuration. For example, the brushes coupled to the positive terminal of a DC motor may be of the curved configuration (since it has been found that positively coupled brushes wear at a faster rate than negatively coupled brushes) while the brushes coupled to the negative terminal of the DC motor may be of a straight configuration.

With regard to the types of materials that may be used for the curved brush 404, it is noted that graphite brushes are typically made by compacting powder in a mold, followed by sintering to fuse the powder together. This same process may be used in the manufacture of the curved brushes disclosed herein, with the direction of compaction force acting parallel to the axis of curvature. With this compaction configuration, there is therefore no limitation to the “angle of wrap” of the curved brush.

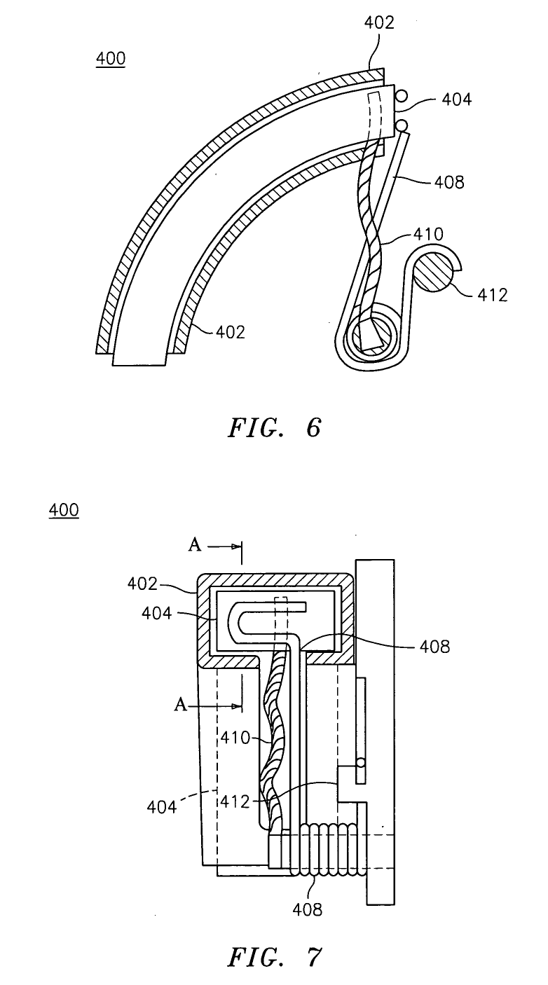

As further depicted in FIGS. 4-5, a torsion spring 408 is used, which may include a large number of turns (to keep the spring rate low), without increasing the packaging size for the spring. The arc through which the torsion spring 408 sweeps naturally follows the motion of the curved brush 404, thus keeping the assembly compact. In addition, by positioning the brush shunt connection near the center of the brush curvature, the same length brush shunt (approximately equal to the mean radius of brush curvature) is provided throughout the entire range of brush position. This also tends to keep the assembly compact. For example, FIGS. 6 and 7 illustrate further details on how the torsion spring 408 and brush shunt 410 might be configured, in one embodiment, with the curved brush assembly 400 for the DC motor 401. In particular, the view illustrated FIG. 6 is taken along the lines A-A of FIG. 7. The torsion spring 408 has an end thereof disposed around a reaction post 412 of the brush assembly 400.

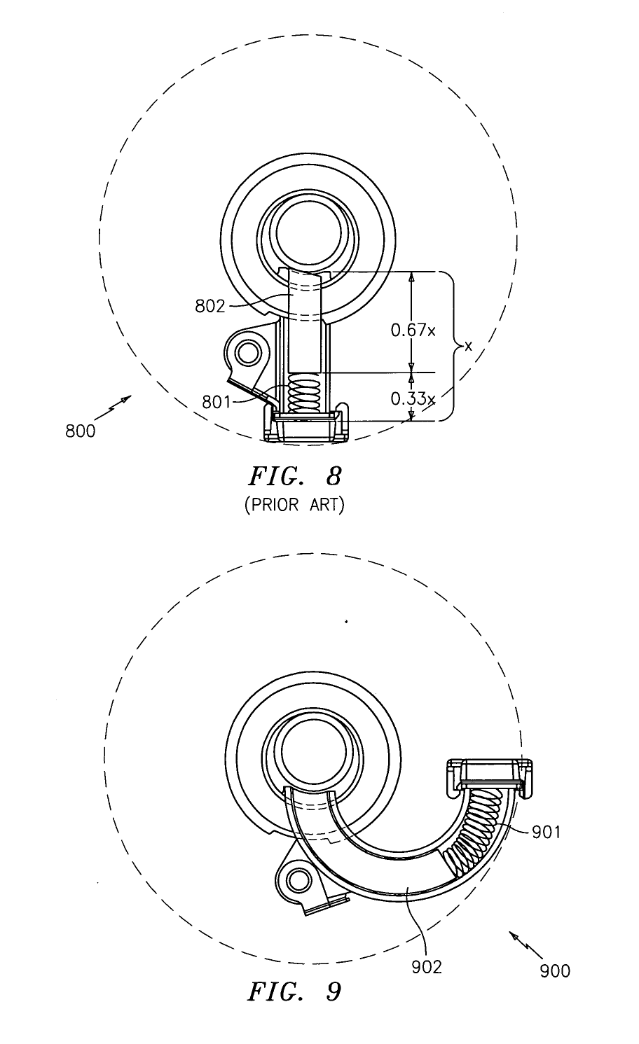

Finally, FIGS. 8 and 9 illustrate a side-by-side comparison of a conventional brush assembly 800 for an alternator (FIG. 8) with a curved brush assembly 900 for an alternator (FIG. 9), in accordance with a further embodiment of the invention. In both the conventional brush assembly 800 and the curved brush assembly 900, helical springs (801, 901, respectively) are used to bias the brushes against the slip rings of the alternator. As illustrated in FIG. 8, for the straight brush assembly, the brush length is about twice the length of the helical spring 801. That is, the brush 802 comprises about ⅔ of the total brush assembly length, x. On the other hand, with the curved brush assembly 900 of FIG. 9, and maintaining roughly the same initial brush-to-spring length, the length of the curved brush 902 is about 89% larger than that of straight brush 802. Again, it should be understood that such a comparison is only illustrative in nature, and that different lengths and curve radii of curved brush assembly 900 may be used.

For the curved brush assembly 900 in the alternator (as well as for the DC motor) application, it may be beneficial to use conductive grease inside the curved brush holder, to minimize friction forces acting on the spring 901. Non-conductive grease could alternatively be used for the same purpose, although this would be less desirable in the event the grease were to come in contact with the slip rings.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A brush assembly for dynamoelectric machines, comprising:
a curved brush holder; and
a curved brush disposed within said curved brush holder, wherein said curved brush further comprises a substantially constant radius of curvature along an entire length thereof.

2. The brush assembly of claim 1, further comprising a torsion spring configured for biasing said curved brush against a rotating dynamoelectric machine component, wherein said torsion spring is configured to travel along said substantially constant radius of curvature.

3. The brush assembly of claim 1, further comprising a brush shunt coupled to said curved brush, wherein said brush shunt has a length corresponding to said substantially constant radius of curvature.

4. The brush assembly of claim 3, wherein said brush shunt comprises a first end thereof connected at about the center of curvature of said curved brush.

5. The brush assembly of claim 1, wherein said curved brush comprises one of: a graphite material, a carbon material, a metal graphite material, and combinations comprising at least one of the foregoing.

6. A brush assembly for a DC motor, comprising:
a curved brush holder; and
a curved brush disposed within said curved brush holder, wherein said curved brush further comprises a substantially constant radius of curvature along an entire length thereof, with one end of said curved brush configured for traveling contact with a commutator of the DC motor.

7. The brush assembly of claim 6, further comprising a torsion spring configured for biasing said curved brush against said commutator, wherein said torsion spring is configured to travel along said substantially constant radius of curvature.

8. The brush assembly of claim 6, further comprising a brush shunt coupled to said curved brush, wherein said brush shunt has a length corresponding to said substantially constant radius of curvature.

9. The brush assembly of claim 8, wherein said brush shunt comprises a first end thereof connected at about the center of curvature of said curved brush.

10. The brush assembly of claim 6, wherein said curved brush comprises one of: a graphite material, a carbon material, a metal graphite material, and combinations comprising at least one of the foregoing.

11. A brush assembly for an alternator, comprising:
a curved brush holder; and
a curved brush disposed within said curved brush holder, wherein said curved brush further comprises a substantially constant radius of curvature along an entire length thereof, with one end of said curved brush configured for traveling contact with a slip ring of the alternator.

12. The brush assembly of claim 11, further comprising a helical spring configured for biasing said curved brush against said slip ring, wherein said helical spring is configured to travel along said substantially constant radius of curvature.

13. The brush assembly of claim 11, wherein said curved brush comprises one of: a graphite material, a carbon material, a metal graphite material, and combinations comprising at least one of the foregoing.
